(19) United States
(12) Patent Application Publication
(10) Pub. No.: US 2024/0360313 A1
(43) Pub. Date: Oct. 31, 2024

(54) BIO-MODIFIED ASPHALT BINDER

(71) Applicants: Elham Fini, Phoenix, AZ (US); Farideh Pahlavan, Chandler, AZ (US)

(72) Inventors: Elham Fini, Phoenix, AZ (US); Farideh Pahlavan, Chandler, AZ (US)

(21) Appl. No.: 18/648,301

(22) Filed: Apr. 26, 2024

Related U.S. Application Data
(60) Provisional application No. 63/498,662, filed on Apr. 27, 2023.

(51) Int. Cl. C08L 95/00

(52) U.S. Cl. CPC C08L 95/00; C08L 2555/62

(57) ABSTRACT

A bio-modified bitumen includes bitumen including organic compounds, and a bio-oil including phenolic compounds and derived from wood biomass. An organic compound includes a volatile organic compound. A phenolic compound forms hydrogen bonds, covalent bonds, or both with an organic compound in the bitumen. Suitable phenolic compounds include phenol, 2,6-dimethylphenol, 2,6-dimethoxyphenol, benzene-1,2-diol, 4-methylbenzene-1,2-diol, 2-methoxy-4-methylphenol, 4-ethenyl-2-methoxyphenol, and 2-methoxy-4-(prop-2-en-1-yl)phenol.

### CROSS-REFERENCE TO RELATED APPLICATION

This application claims the benefit of U.S. Patent Application No. 63/498,662 filed on Apr. 27, 2023, which is incorporated herein by reference in its entirety.

### STATEMENT OF GOVERNMENT SUPPORT

This invention was made with government support under 1935723 awarded by National Science Foundation. The government has certain rights in the invention.

### TECHNICAL FIELD

This invention relates to a bio-modified bitumen including wood biomass-derived bio-oil that inhibits the emission of volatile organic compounds from asphalt.

### BACKGROUND

Bitumen is a residue derived from petroleum refining that is used to hold stone aggregates together and prevent deformation in an asphalt mixture. Because high-temperature conditions are typical at all stages of asphalt installation, large quantities of fumes are emitted during the production, transportation, construction, and maintenance of asphalt. These fumes are a source of volatile organic compounds (VOCs). Moreover, VOC emissions are not limited to high temperatures. VOCs are emitted from asphalt during its service life at ambient temperatures, and the emissions are intensified under solar irradiation or high temperatures. VOCs function as precursors to the formation of ozone and secondary aerosols that have significant environmental impact. Emissions of asphalt's hazardous air pollutants not only threaten human health but also have adverse effects on the asphalt's durability.

The discharge of volatiles from bitumen into the atmosphere is a mechanism by which asphalt can age. Petroleum bitumen has a range of components, including aliphatic and aromatic hydrocarbons that are categorized into four generic fractions: saturates, aromatics, resins, and asphaltenes (SARA). Bitumen has been typically described as a colloidal system where micelles of polar asphaltenes are dispersed in the oily medium of components with lower molecular weight. Each bitumen fraction has a specific function in the physical properties of asphalt, and a proper balance of chemical components from nonpolar to polar is typically used to create a durable asphalt with desirable physical properties. Oxidative aging causes detrimental changes in physical properties by disturbing the balance among bitumen components, destroying the bitumen's colloidal structure. There are two main phenomena that disturb bitumen's colloidal structure and intensify asphaltene agglomeration during aging: mass loss; and the formation of oxygen-containing functional groups such as carbonyl in the reactive bitumen fractions. The volatile loss of small hydrocarbons starts at an early stage of asphalt aging and continues during aging, caused by heating, solar irradiation, or by free radicals generated by chain scission reactions due at least in part to UV irradiation. These aging-related chemical changes cause changes in bitumen's rheological and chemical properties that decrease asphalt's durability.

### SUMMARY

This disclosure relates to the addition of bio-oils rich in phenolic compounds to bitumen to yield bio-modified bitumen. The phenolic compounds can form stable complexes with bituminous polar organic molecules (e.g., oxygenated compounds) and inhibit the release of these organic molecules from the bitumen matrix. Functional groups on the phenolic compounds influence the strength of the intermolecular interactions. By facilitating the retention of these small organic compounds, the addition of phenol-rich bio-oil to bitumen inhibits the release of volatile organic compounds (VOCs) into the atmosphere.

Thermochemical conversion of lignin, the dominant macromolecule in wood biomass, produces a phenol-rich bio-oil. Quantum-based molecular modeling and laboratory experiments indicate the capability of bio-oil derived from wood biomass (e.g., wood pellets) to limit the volatilization of small bitumen molecules, suppress asphalt mass loss, and delay asphalt aging, thus providing both environmental and economic advantages.

In a first general aspect, a bio-modified bitumen includes a bitumen including organic compounds, and a bio-oil including phenolic compounds and derived from wood biomass. The phenolic compounds formhydrogen bonds, covalent bonds, or both with the organic compounds in the bitumen.

Implementations of the first general aspect can include one or more of the following features.

The organic compounds can include volatile organic compounds (VOCs). A phenolic compound can include one or more functional groups selected from —CH₃, —C₂H₃, —C₃H₅, —CHO, —OCH₃, and —OH. In some implementations, a phenolic compounds include phenol, 2,6-dimethylphenol, 2,6-dimethoxyphenol, benzene-1,2-diol, 4-methylbenzene-1,2-diol, 2-methoxy-4-methylphenol, 4-ethenyl-2-methoxyphenol, and 2-methoxy-4-(prop-2-en-1-yl)phenol. The bio-modified bitumen can include crumb rubber particles (e.g., about 5 wt % to about 15 wt % of the crumb rubber particles). The wood biomass can include wood pellets.

In a second general aspect, a building material includes the bio-modified bitumen of the first general aspect.

In third general aspect, a bio-modified asphalt includes a bio-modified bitumen of the first general aspect and aggregate material.

In some implementations, the aggregate material can include one or more of rock, sand, gravel, and slags.

In a fourth general aspect, a building material includes the bio-modified asphalt of the third general aspect.

The details of one or more embodiments of the subject matter of this disclosure are set forth in the accompanying drawings and the description. Other features, aspects, and advantages of the subject matter will become apparent from the description, the drawings, and the claims.

### BRIEF DESCRIPTION OF DRAWINGS

FIG. 1 illustrates the formation of hydrogen-bonded complexes between each of nine wood-pellet (WP) phenolic compounds and each of eight types of oxygenated compounds in bitumen.

FIG. 2 is a graph showing the linear relationship between ΔE and ρ_{BCP} values calculated at the bond critical points (BCPs) for complexes of WP phenolic compounds and an oxygenated compound.

FIG. 3 is a graph showing the linear relationship between ΔE and nucleus-independent chemical shift (NICS) index values for complexes of WP phenolic compounds and an oxygenated compound.

FIGS. 4A-4D are graphs of the complex modulus at 52° C. after different UV exposure times of the following bitumen samples: neat PG 64-22; crumb-rubber-modified (CRM); wood-pellet bio-modified rubberized (WP-BMR); and waste vegetable oil bio-modified rubberized (WVO-BMR), respectively.

FIGS. 5A-5D are graphs of the phase angles at 52° C. after different UV exposure times of the following bitumen samples: neat PG 64-22; CRM; WP-BMR; and WVO-BMR, respectively.

FIG. 6 is a graph of G*/sin δ at 52° C. as a function of UV exposure time for the following bitumen samples: neat PG 64-22; CRM; WP-BMR; and WVO-BMR.

FIGS. 7A and 7B are graphs of the crossover modulus and crossover frequency, respectively, at 10° C. as a function of UV exposure times for the following bitumen samples: neat PG 64-22; CRM; WP-BMR; and WVO-BMR.

FIG. 8 is a graph of the activation energy as a function of UV exposure times for the following bitumen samples: neat PG 64-22; CRM; WP-BMR; and WVO-BMR.

### DETAILED DESCRIPTION

This disclosure describes the addition of bio-oils including phenolic compounds to bitumen to retain volatile organic compounds (VOCs) within the bituminous matrix. The molecular structure of the phenolic compounds can facilitate the formation of stable interaction complexes with lightweight bituminous organic compounds, preventing the release of VOCs into the atmosphere.

The properties of bio-modified bitumen made with bio-oil derived from wood biomass are compared with those of neat bitumen, rubberized bitumen, and bio-modified bitumen made with bio-oil derived from waste vegetable oil. Thermochemical conversion of lignin, the dominant macromolecule in wood-based biomass, produces a phenol-rich bio-oil. Density functional theory (DFT) calculations indicate that the phenol-rich bio-oils derived from wood biomass (e.g., wood-pellets) have advantageous properties for the adsorption of oxygenated organic compounds in bitumen. The effectiveness of wood-pellet (WP) bio-oil can be demonstrated by higher binding energies calculated for the interaction of WP bio-oil phenolic components with oxygenated compounds in bitumen compared to the binding energy values calculated for the interaction between the dominant components of waste vegetable oil (WVO) with the oxygenated compounds. The presence of aryl groups and hydroxyl groups in the molecular structure of phenolic compounds increases the capability of the aryl groups and hydroxyl groups to adsorb oxygenated organic compounds in bitumen through hydrogen bonding interactions. The thermodynamic stability of interacting complexes of WP phenolic molecules and small oxygenated compounds in bitumen mitigates molecular loss from bitumen, thereby reducing the release of VOCs to the atmosphere, and increasing the durability of bitumen subjected to UV irradiation.

The electronic character (e.g., electron withdrawing or electron donating), the position, and the number of substituents attached to the phenolic ring influence the electron density distribution over a phenolic compound and impact the strength of interaction with an oxygenated compound in bitumen. Electron-donating substituents increase the electron density in the aryl ring of a phenolic structure and increase the electron density in the interacting path between the phenol and an oxygenated compound. This electron delocalization increases the strength of hydrogen bonding and increases the thermodynamic stability of the interacting complexes formed.

The efficacy of wood-based bio-oils to mitigate oxidative aging is also influenced by the concentration and molecular structure of the phenolic compounds present. Phenolic compounds acting as antioxidants have the capability to scavenge free radicals formed by oxidative aging and thereby prevent the formation of new polar functional groups (including carbonyl) and prevent agglomeration in the bitumen. Bitumen samples modified with WVO bio-oil or WP bio-oil have a lower extent of aging compared to that of neat bitumen and rubberized bitumen. There is a reduction of aging in the case of WP-modified bitumen compared to WVO-modified bitumen.

Bio-modified bitumen includes a bio-oil including phenolic compounds and derived from wood biomass. The phenolic compounds form hydrogen bonds, covalent bonds, or both with organic compounds in the bitumen, preventing the release of the organic compounds into the environment. The wood biomass used to make the bio-oil can include wood pellets. The bio-modified bitumen can include about 5 wt % to about 15 wt % of the bio-oil. The phenolic compounds can include one or more of the functional groups —CH₃, —C₂H₃, —C₃H₅, —CHO, —OCH₃, and OH. The bio-modified bitumen can include crumb rubber particles. The bio-modified bitumen can include about 5 wt % to about 15 wt % of the crumb rubber particles.

### EXAMPLES

Materials. The neat bitumen was performance grade PG 64-22 (indicating highest pavement service temperature of 64° C. and lowest pavement service temperature of −22° C.). Table 1 provides the basic properties of bitumen PG 64-22. Crumb rubber was produced from scrap tires made from synthetic rubber and natural rubber. The crumb rubber included 23.5% carbon black and had particle size smaller than 40 mesh. Bio-oils were derived from wood pellets (WP) and waste vegetable oil (WVO). The basic properties of the bio-oils are presented in Table 2. Solvent separation was used to separate each modified bitumen into four generic fractions. Certain compounds in bio-oils that are insoluble in n-heptane are categorized as asphaltenes, even though there are chemical and molecular differences between compounds named asphaltenes. To compare the effect of the bio-oils, neat bitumen and crumb-rubber-modified bitumen (CRM) were also analyzed.

TABLE 1
Basic properties of neat bitumen PG 64-22

| Properties | Values | | Testing methods |
|---|---|---|---|
| Specific gravity @15.6° C. | 1.041 | | ASTM D70 |
| Penetration @25° C. | 70 (0.1 mm) | | ASTM D5 |
| Softening point | 46.0° | C. | ASTM D36 |
| Ductility @ 15° C. | >100 | cm | ASTM D113 |
| Cleveland open cup method flash point | 335° | C. | ASTM D92 |
| Mass change after rolling thin-film oven | −0.013% | | ASTM D6 |
| Absolute viscosity @ 60° C. | 179 | Pa · s | ASTM D2171 |
| Stiffness @−12° C., 60 s | 85.8 | MPa | ASTM D6648 |

TABLE 2
Basic properties of bio-oil from wood pellets
(WP) and bio-oil from waste vegetable oil (WVO)

| | | |
|---|---|---|
| Properties | WP | WVO |

| Density (g/cm³) | | | 1.230 | 0.898 |
|---|---|---|---|---|
| Shear modulus @50° C., 10 Hz (Pa) | | | 923.6 | 26.8 |
| | Elements (%) | Carbon | 61.05 | 77.30 |
| | | Hydrogen | 6.93 | 12.08 |
| | | Oxygen | 31.81 | 10.50 |
| | | Nitrogen | 0.21 | 0.12 |
| | Components* (%) | Saturates | 3.46 | 0.00 |
| | | Aromatics | 2.93 | 87.19 |
| | | Resins | 76.21 | 12.80 |
| | | Asphaltenes | 17.38 | 0.00 |

*Thin-layer chromatography with flame ionization detection (TLC-FID) was used for the SARA fractions analysis.

Modification of bitumen. Bio-modified rubberized bitumen (BMR) was prepared by mixing 15% bio-oil and 15% crumb rubber into PG 64-22 by weight of base binder. A high-shear mixer at 3000 rpm for 30 min at 180±5° C. was used for shearing and blending. Two types of bio-oils, WP and WVO, were used to prepare BMR specimens: WP-BMR and WVO-BMR.

UV aging of bitumen. Samples of WP-BMR and WVO-BMR were UV aged by using an accelerated weathering tester (UVA 0.71 W/m²/nm @340 nm) to simulate the UV irradiation of sunlight. To prepare a uniform thin film of a sample for UV aging, the preheated sample was spread over a silicon rubber pan with a diameter of 75 mm, then the pan was placed in an oven at 140° C. for 20 min. The average thickness of each specimen was −0.7 mm. All specimens were placed in the UV chamber under continuous exposure at 60° C. for periods of 50, 100, and 200 h.

Tests of rheological properties. A dynamic shear rheometer was used to measure the elastic and viscous properties of neat, rubberized, and bio-modified rubberized bitumen samples, following ASTM D7175 standard test methods. An oscillation test was conducted at 52° C. using a parallel-plate setup with 8-mm diameter and 2-mm thickness, at a strain rate of 0.1% and a frequency range of 0.1-100 rad/s. The complex modulus (G*) and phase angle (δ) were calculated for all specimens using Eq. 1. The crossover values can be used to measure the extent of aging in a bitumen sample. The crossover modulus (G*_{c}) and crossover frequency (f_{c}) were determined by measuring the modulus and frequency at 10° C. and a phase angle of 45 degrees.

UV aging affects the polarity and molecular composition of bitumen, influencing the intermolecular interactions within the bitumen matrix and leading to variations in the activation energy of bitumen. The viscosity of each sample was quantified at temperatures of 50° C., 60° C., and 70° C. by flow sweep. Measured viscosities were applied to calculate the activation energy (Eₐ) using Eq. 2.

$${G}^{*} = \frac{{τ}_{max}}{{γ}_{max}} \qquad ( 1 )$$

$$in which {τ}_{max} = \frac{2 T}{π {r}^{3}} , {γ}_{max} = ( \frac{θ r}{h} ) ,$$

γₘₐₓ=maximum strain
τₘₐₓ=maximum stress
T=maximum applied torque
R=radius of the sample
θ=deflection (rotational) angle, and
h=height of the sample.

$$ln η = ln A + \frac{{E}_{a}}{RT} \qquad ( 2 )$$

in which
   η is the bitumen viscosity (Pa·s) at temperature T (K)
   Eₐ is the activation energy (J·mol⁻¹)
   R is the universal gas constant (8.314 J·mol⁻¹·K⁻¹), and A is the pre-exponential factor.

Attenuated total reflectance Fourier transform infrared spectroscopy (ATR-FTIR). To evaluate the extent of oxidative aging and the effect of UV irradiation on the molecular composition of neat and bio-modified bitumen (e.g., asphalt binder), the functional groups were characterized. To do this, an FTIR spectrometer with diamond ATR was used to determine the changes in the functional groups of bitumen samples as an effect of UV aging. Acetone was applied to clean the diamond crystal surface before testing. The background spectrum was collected first and subtracted from a tested sample's spectrum. Wavenumbers ranging from 400 cm⁻¹ to 4800 cm⁻¹ were collected with a scan frequency of 32 times/min at a resolution of 4 cm⁻¹ in a vacuum environment.

Chemical analysis. Free radicals generated by UV exposure can increase the formation of carbonyl groups by attacking unsaturated groups, producing oxidized products such as ketones and carboxylic acids. To determine the aging propensity of each type of bitumen sample (neat, rubberized, or bio-modified), the peaks of the stretching vibration of carbonyl groups in the FTIR spectra at 1740 cm⁻¹ were determined. For the quantitative analysis of these functional groups, the spectra were first normalized with aliphatic peaks, then the peak absorbance areas were measured. The bond index of the carbonyl group for the bitumen sample was calculated using Eq. 3.

$$Carbonyl Index = \frac{Area under curve from 1680 - 1800 {cm}^{- 1}}{Area under curve from 600 - 4000 {cm}^{- 1}} \times 100 \qquad ( 3 )$$

Computation Details. To evaluate the capability of phenolic components to retain volatile oxygenated compounds in bitumen, the interactions of phenolic components with target oxygenated compounds were modeled using a quantum mechanical approach in the framework of density functional theory (DFT), available in the Gaussian 16 package. All molecular structures and interacting complexes in this study were optimized using M05-2X as a hybrid meta exchange-correlation functional and 6-31+G* as basis set. Computations were followed by harmonic vibrational frequency calculations at the same level of theory, to confirm stationary points as transition minima on the potential energy surfaces.

The binding energies (ΔE), as a measure of the thermodynamic stability of interacting complexes, were computed as a difference between the total energy of the complex and the sum of the energies of the isolated monomers as indicated by Eq. 4.

$$Δ E = {E}_{complex} - Σ {E}_{isolated monomers} \qquad ( 4 )$$

Electronic analysis was used to gain insight into the influence of the molecular structure of phenolic compounds (as predominant molecules in the WP bio-oil) on the possible mechanisms involved in the retention of oxygenated compounds in bio-modified bitumen (BMR). The nucleus-independent chemical shift (NICS) index was used to measure aromaticity in the aryl group of different phenolic compounds. In addition, quantum theory of atoms in molecules (QTAIM) analysis was performed on all optimized complexes by using the AIM2000 program to calculate the electron density, ρ(r), at the bond critical points of interacting paths, to evaluate the strength of interactions between phenols and oxygenated compounds. All wave functions were generated at the M05-2X/6-31+G* level.

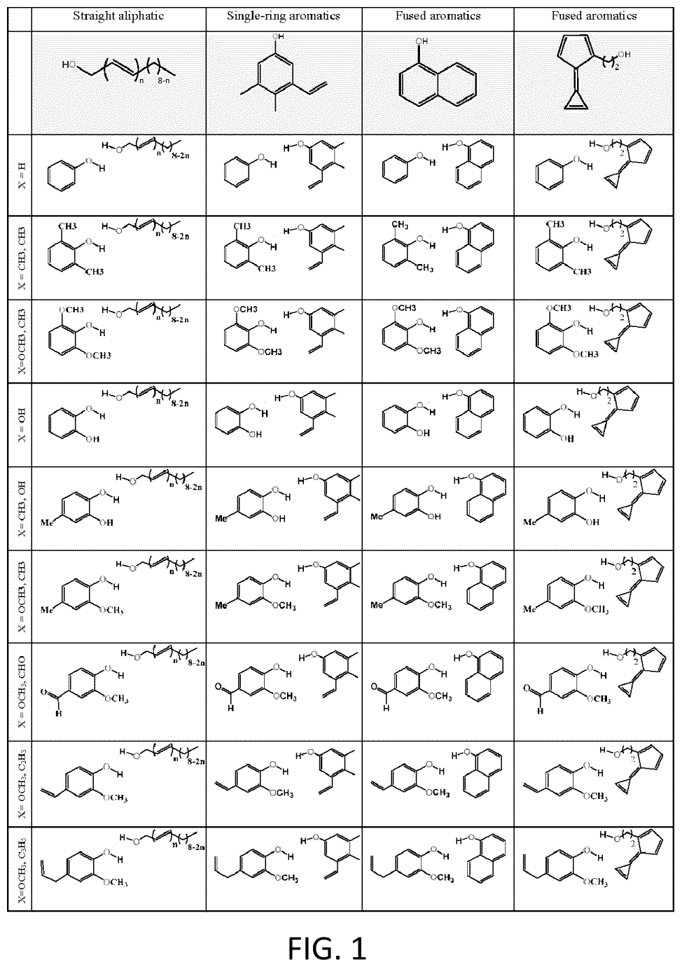

DFT-based molecular modeling-binding energies. The objective of DFT energy calculations is to model the strength of interaction between the components of the WP bio-oil and the oxygenated compounds in bitumen (e.g., asphalt binder). This part of the computations was conducted to address two themes: how phenolic compounds in the WP bio-oil retain volatile organic molecules in the bitumen; and whether certain phenols are better than other phenols at trapping volatile organic molecules. Phenol is a strong hydrogen-bond donor, and hydrogen bonding is a common feature of molecular reactivity. The effectiveness of phenolic compounds in trapping oxygenated compounds in bitumen is related to the ability of the phenolic compounds to form hydrogen bonding with the functional group of oxygenated compounds. The presence of a hydroxyl group in the molecular structure of a phenolic compound is known as an active center involved in the intermolecular hydrogen-bonding interactions. The bitumen volatiles for these DFT calculations consisted of eight oxygenated compounds selected from molecules detected in asphalt-related emissions. The eight oxygenated compounds are shown in the first row of FIG. 1; the structural formula shown in the heading for the straight aliphatic column of FIG. 1 is a condensed formula representing five oxygenated compounds that differ in the number of double bonds. Complexes of WP and oxygenated compounds were optimized at the M05-2X/6-31+G* level of theory. Hydrogen-bonding interaction is shown with a dashed line. X represents the phenolic substituents. The formation of hydrogen-bonded complexes between each of nine WP phenolic compounds with different structural substituents and each of eight oxygenated compounds in bitumen shown in FIG. 1 was investigated. The phenolic compounds include phenol; 2,6-dimethylphenol; 2,6-dimethoxyphenol; benzene-1,2-diol; 4-methylbenzene-1,2-diol; 2-methoxy-4-methylphenol; 4-ethenyl-2-methoxyphenol; and 2-methoxy-4-(prop-2-en-1-yl)phenol. The stronger interaction of oxygenated compounds with WP phenolic compounds could be rationalized as stronger hydrogen-bonding interactions. The strength of interactions in a complex of WP and an oxygenated compound was calculated in terms of the binding energies, ΔE. As listed in Table 3, ΔE values are in the range of −25.88 to −91.61 kJ/mol. An increased O—H binding energy is consistent with an increased tendency for the phenol to interact with oxygenated compounds, which is consistent with better scavenging activity and better anti-aging efficacy.

According to the data given in Table 3, the highest ΔE is calculated for interacting complexes involving the WP phenolic compound with OCH₃ and CH₃ substituents, and the lowest ΔE is calculated for those formed by the interaction of the WP phenol without substituents (X═H in Table 3). Comparing all energy values listed in Table 3 with the corresponding values for the unsubstituted phenol complexes, all phenolic substituents enhance the strength of hydrogen bonding with oxygenated compounds in bitumen and increase the magnitude of the binding energies (values that are more negative). The trend observed for the effectiveness of phenolic substituents to increase the reactivity of a phenolic compound to interact with oxygenated compounds in bitumen is as follows (listed from strongest to weakest): (OCH₃, CH₃)>(OCH₃, C₂H₃)>(OCH₃, OCH₃)>(OCH₃, CHO)>(CH₃, CH₃)>(OCH₃, C₃H₅)>(CH₃, OH)>OH>H. In one example, the electronic nature of the substituents attached to a phenolic compound is a factor that contributes to the strength of hydrogen-bonding interactions and the phenol's effectiveness in trapping oxygenated organic compounds in bitumen. The electron-donating substituents act as activating groups for the phenolic moiety (Aryl-OH) and increase the π-electron cloud in the WP phenol ring, improving the charge transfer from the phenol ring to its oxygen atom. This electronic behavior could increase the proton-accepting characteristic of phenol, leading to more favorable hydrogen bonding with an oxygenated compound and a more stable interacting complex. As the substituents become more electron-donating in complexes of WP and an oxygenated compound, the binding energies increase, as shown in Table 3.

TABLE 3
Calculated binding energies (in kJ mol⁻¹) for complexes of WP and an oxygenated compound in bitumen

| WP Phenolic | Oxygenated Compounds | | | | | | | |
|---|---|---|---|---|---|---|---|---|
| Compounds¹ | C₁₀H₂₂O | C₁₀H₂₀O | C₁₀H₁₈O | C₁₀H₁₆O | C₁₀H₁₄O | C₁₀H₁₂O | C₁₀H₁₀O | C₁₀H₈O |
| X = H | −25.88 | −34.29 | −36.43 | −42.72 | −43.01 | −43.29 | −47.69 | −50.14 |
| X = CH₃, CH₃ | −34.23 | −49.99 | −53.31 | −51.21 | −51.92 | −53.71 | −69.92 | −73.26 |
| X = OCH₃, CH₃ | −49.73 | −68.30 | −71.49 | −79.28 | −83.48 | −84.85 | −88.35 | −91.61 |
| X = OCH₃, C₂H₃ | −49.19 | −67.36 | −70.45 | −78.30 | −78.80 | −75.34 | −79.72 | −79.88 |
| X = OCH₃, C₃H₅ | −27.88 | −47.14 | −50.28 | −52.17 | −52.20 | −63.22 | −69.01 | −72.56 |
| X = CH₃, OH | −27.82 | −46.88 | −49.40 | −52.08 | −65.90 | −66.86 | −66.32 | −72.40 |
| X = OCH₃, CHO | −41.80 | −48.84 | −56.75 | −54.16 | −47.72 | −64.36 | −72.45 | −74.58 |
| X = OCH₃, OCH₃ | −41.90 | −49.30 | −61.84 | −63.98 | −68.84 | −72.46 | −74.92 | −75.19 |
| X = OH | −27.38 | −46.22 | −48.25 | −49.04 | −48.58 | −46.31 | −55.02 | −71.76 |

¹X represents the substituents

Other factors influencing the observed trend for the effectiveness of substituents include having steric hindrance, a propensity to accept hydrogen bonds, electron-withdrawing characteristics, and unsaturated bonds. For example, O—CH₃ is an effective hydrogen bond acceptor, so the phenolic hydroxyl (O—H) can be involved in intramolecular hydrogen bonding; thus, the strength of intermolecular hydrogen bonding is decreased. The presence of CH═CH₂ (C₂H₃) in the para position with respect to the phenolic hydroxyl favors a conjugation and resonance effect, affecting the stabilization of the interacting complex. An electron-withdrawing group such as CHO deactivates the phenolic ring and thereby decreases the corresponding binding energies.

To verify the efficacy of WP bio-oil phenolic molecules to trap bitumen's oxygenated compounds, the energy data listed in Table 3 were compared with the corresponding values for the interaction of waste vegetable oil (WVO) molecules with the same bitumen oxygenated compounds. The calculated binding energies due at least in part to the interaction between the dominant WVO compounds and oxygenated compounds at the same level of theory range from −16.28 to −54.93 kJ/mol. This comparison showed that complexes of WP and an oxygenated compound are more thermodynamically favorable than the complexes of WVO and the oxygenated compound, due at least in part to the effective structural features of WP compounds. DFT-based energy evaluation of the interaction strength of WP and WVO compounds with oxygenated compounds of bitumen shows that the WP phenolic compounds perform better at retaining the volatile compounds in the bitumen matrix and delaying emission of the volatile compounds.

Atoms-in-molecules (AIM) analysis. To examine the strength of interactions between molecules in the bio-oil and the organic oxygenated compounds in bitumen, electron density analysis in the intermolecular region was performed using the framework of AIM theory. Based on AIM theory, a bond path is a trajectory of concentrated electron density (ρ) connecting a pair of bonded atoms, and bond critical points (BCPs) are electron-density extremes. Table 4 lists the electron density at bond critical points (ρ_{BCP}) on the —O—H— interaction paths for the optimized complexes of WP and an oxygenated compound. Values of electron density were used for qualitative comparison of hydrogen-bond strength for all complexes; a small electron density at a bond critical point indicates a weak interaction between the WP phenolic component and the oxygenated compound. The electronic characteristics of phenolic substituents can influence the accumulation of electron density in the intermolecular region and influence the stability of an oxygenated compound over a phenolic component. Considering the ρ_{BCP} values listed in Table 4, there is a direct relationship between the electron density at the bond critical point of —O—H— interactions and the electron-donating nature of substituents: more electron-donating characteristics lead to a higher ρ_{BCP} value. The addition of an electron-withdrawing group or even an electron-donating group that brings steric hindrance in the interaction region will reduce the effectiveness of the electron-donating group to produce electron condensation between two interacting molecules. The calculated electron densities show that a phenolic compound with OCH₃ and CH₃ substituents shows the highest ρ_{BCP} in interactions with most of the oxygenated compounds considered in this study, and a phenol without substituent (X═H in Table 4) shows the lowest.

TABLE 4
Calculated electron densities (ρ in e/a₀³) at —O . . . H—
BCP for complexes of WP and an oxygenated compound

| WP Phenolic | Oxygenated Compounds | | | | | | | |
|---|---|---|---|---|---|---|---|---|
| Compounds¹ | C₁₀H₂₂O | C₁₀H₂₀O | C₁₀H₁₈O | C₁₀H₁₆O | C₁₀H₁₄O | C₁₀H₁₂O | C₁₀H₁₀O | C₁₀H₈O |
| X = H | 1.864 | 2.451 | 2.511 | 2.611 | 2.751 | 2.864 | 2.931 | 3.124 |
| X = CH₃, CH₃ | 1.924 | 2.776 | 2.854 | 2.954 | 2.996 | 3.116 | 3.216 | 3.321 |
| X = OCH₃, CH₃ | 2.166 | 2.638 | 2.691 | 2.791 | 2.838 | 3.166 | 3.266 | 3.462 |
| X = OCH₃, C₂H₃ | 2.082 | 2.626 | 2.702 | 2.772 | 2.826 | 3.108 | 3.113 | 3.214 |
| X = OCH₃, C₃H₅ | 2.150 | 2.517 | 2.616 | 2.716 | 2.817 | 3.150 | 3.210 | 3.370 |
| X = CH₃, OH | 2.023 | 2.575 | 2.587 | 2.687 | 2.875 | 3.123 | 3.202 | 3.336 |
| X = OCH₃, CHO | 1.929 | 2.517 | 2.589 | 2.689 | 2.717 | 3.146 | 3.216 | 3.326 |
| X = OCH₃, OCH₃ | 2.155 | 2.383 | 2.757 | 2.757 | 2.983 | 3.155 | 3.135 | 3.367 |
| X = OH | 2.088 | 2.567 | 2.571 | 2.771 | 2.887 | 3.088 | 3.212 | 3.401 |

¹X represents the substituents

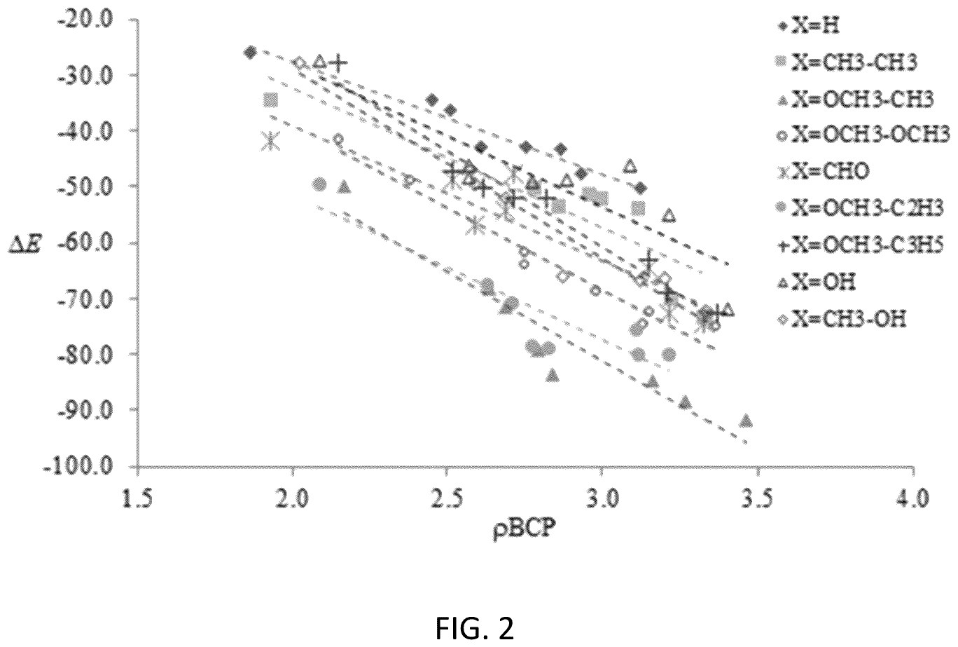

The trend observed for ρ_{BCP} values is inversely correlated with binding energy (ΔE): ΔE decreases (binding strength increases) as the electron density (ρ_{BCP}) at the bond critical point of a hydrogen bond increases, as shown in FIG. 2. FIG. 2 was plotted using the ΔE and ρ_{BCP} values listed in Table 3 and Table 4.

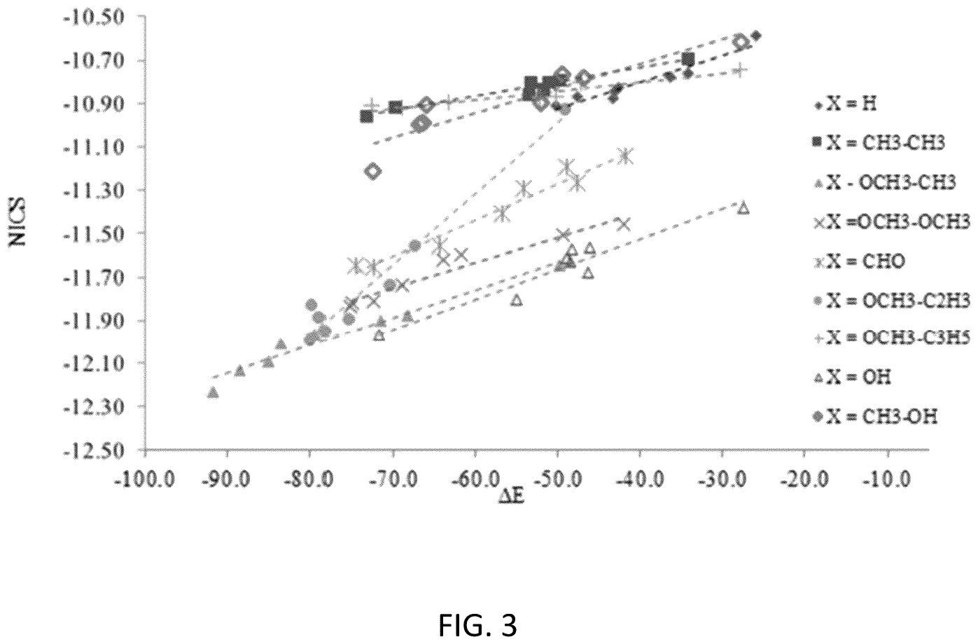

Nucleus-independent chemical shift (NICS) index. The aromaticity of the ring in the phenolic structure changes when the WP phenolic component is substituted with different groups and when the WP phenolic component participates in hydrogen-bonding interactions with different oxygenated compounds. The NICS index was studied to identify the aromatic character of WP phenolic components in all considered complexes of WP molecules with an oxygenated compound. The NICS values at 1.0 Å above the molecular plane, denoted as NICS(1), are listed in Table 5. The NICS data in Table 5 show that the electronic nature of phenolic substituents and the electronic nature of bound oxygenated compounds influence the electron delocalization throughout the interacting complex and its stabilization. Electron-donating substituents attached to the phenolic compound increase its aromaticity and improve electron delocalization in the interacting complex, producing increased binding energy and a more stabilized complex. In addition to the substituents' electronic character (e.g., electronic withdrawing or electron donating), the position and the number of substituents attached to the phenolic ring alter its aromaticity. The phenolic compound with OCH₃ and CH₃ substituents has the largest NICS(1) value; a more negative NICS value indicates a more aromatic ring. The values for aromaticity and binding energies (ΔE) (Table 3) are correlated, where an increase in ΔE corresponds to an increase in NICS, as shown in FIG. 3.

TABLE 5
Calculated NICS¹ values of complexes of WP and an oxygenated compound

| WP Phenolic | Oxygenated Compounds | | | | | | | |
|---|---|---|---|---|---|---|---|---|
| Compounds¹ | C₁₀H₂₂O | C₁₀H₂₀O | C₁₀H₁₈O | C₁₀H₁₆O | C₁₀H₁₄O | C₁₀H₁₂O | C₁₀H₁₀O | C₁₀H₈O |
| X = H | −10.589 | −10.765 | −10.779 | −10.824 | −10.845 | −10.879 | −10.866 | −10.914 |
| X = CH₃, CH₃ | −10.692 | −10.792 | −10.794 | −10.801 | −10.832 | −10.853 | −10.912 | −10.956 |
| X = OCH₃, CH₃ | −11.647 | −11.877 | −11.898 | −11.971 | −12.013 | −12.090 | −12.133 | −12.229 |
| X = OCH₃, C₂H₃ | −10.929 | −11.554 | −11.737 | −11.950 | −11.888 | −11.895 | −11.827 | −11.994 |
| X = OCH₃, C₃H₅ | −10.742 | −10.800 | −10.869 | −10.875 | −10.865 | −10.895 | −10.920 | −10.912 |
| X = CH₃, OH | −10.621 | −10.784 | −10.764 | −10.898 | −10.910 | −10.994 | −10.991 | −11.213 |
| X = OCH₃, CHO | −11.145 | −11.192 | −11.405 | −11.293 | −11.269 | −11.554 | −11.650 | −11.644 |
| X = OCH₃, OCH₃ | −11.458 | −11.509 | −11.597 | −11.623 | −11.737 | −11.810 | −11.821 | −11.836 |
| X = OH | −11.378 | −11.562 | −11.569 | −11.610 | −11.631 | −11.682 | −11.801 | −11.972 |

¹X represents the substituents

Evaluation of aging indices. To evaluate the extent of change in the properties of each bitumen sample after aging, aging indices based on the metrics used in this section were calculated using Eq. 5.

$$AI = \vert \frac{aged value - unaged value}{unaged value} \vert \times 100 \% \qquad ( 5 )$$

The values for seven aging indices are provided in Table 6.

TABLE 6
Aging indices using studied indicators for neat bitumen (PG 64-
22), crumb-rubber-modified bitumen (CRM), and two bio-modified
rubberized bitumens (WP-BMR and WVO-BMR) after 200 h UV exposure

| | | | | WP- | WVO- | The bitumen most |
|---|---|---|---|---|---|---|
| Bitumens | | PG 64-22 | CRM | BMR | BMR | resistant to UV aging |
| Aging | G* @ 52° C., 10 | 345.3 | 280.0 | 220.8 | 268.5 | WP-BMR |
| indexes | δ @ 52° C., 10 rad/s | 12.9 | 16.1 | 8.6 | 7.7 | WVO-BMR |
| based | G*/sinδ @ 52° C. | 327.2 | 241.6 | 234.7 | 275.1 | WP-BMR |
| on | G*_{c} @ 10° C. | 45.0 | 36.0 | 23.0 | 44.9 | WP-BMR |
| (%) | f_{c} @ 10° C. | 93.5 | 96.6 | 81.8 | 93.5 | WP-BMR |
| | Eₐ | 13.6 | 14.4 | 11.5 | 12.9 | WP-BMR |
| | I_{C═O} | 114.4 | 70.2 | 56.8 | 19.9 | WVO-BMR |

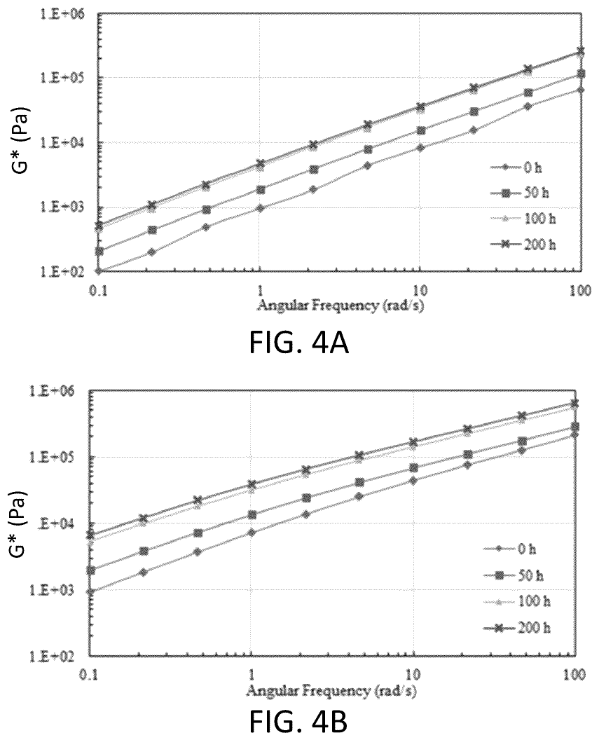

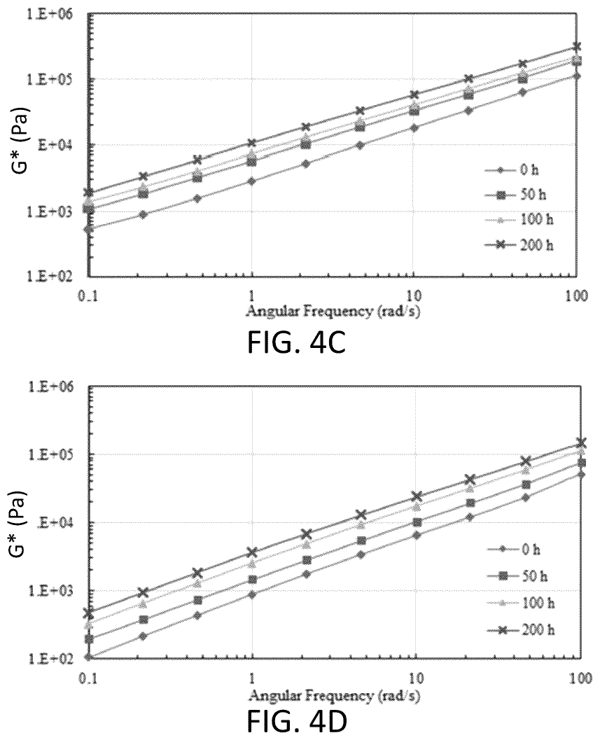

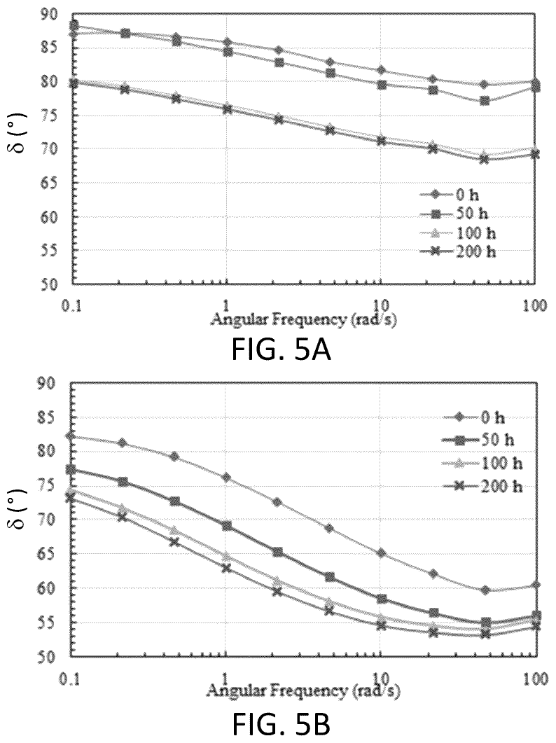

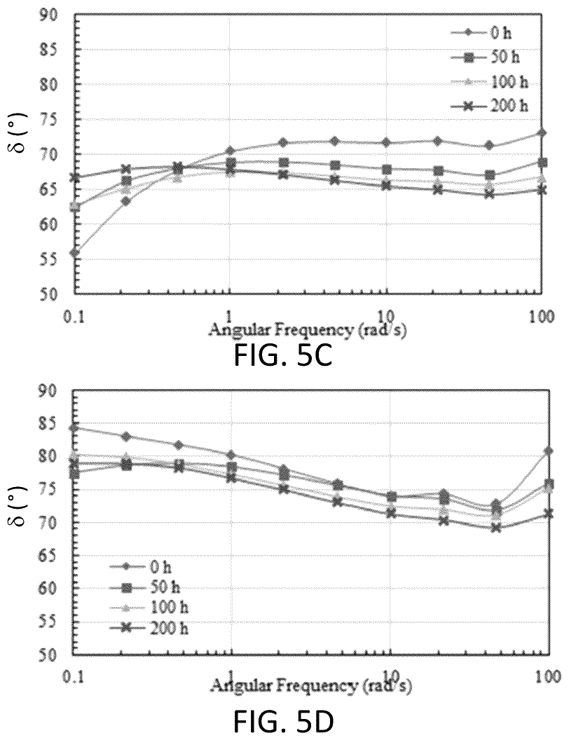

Analysis of complex modulus and phase angles. The complex modulus (G*) and the phase angle (δ) of neat bitumen, crumb-rubber-modified bitumen, and the two types of bio-modified rubberized bitumen at 52° C. are shown in FIGS. 4A-4D and FIGS. 5A-5D, respectively. These figures show a decrease in δ and an increase of G* for all bitumen samples as aging progressed, indicating the hardening of bitumen. The observed bitumen hardening could be associated with a loss of volatiles and with chemical changes such as aromatization and carbonation. Both the loss of volatiles and the chemical changes occur in bitumen throughout UV aging. Among the tested samples, the rubberized bitumen containing the WP bio-oil showed the lowest change in G* (G*-based aging index) of 220.8% after UV exposure for 200 h, indicating better resistance to UV aging; neat bitumen showed the highest G*-based aging index of 345.3%, indicating the worst UV aging resistance as provided in Table 6.

As shown in FIGS. 4A-4D and 5A-5D, the G* graphs of all bitumens had the same pattern, while the δ graphs presented different shapes, such as a plateau or peak at the intermediate-frequency region, decreased δ in the low-frequency region, or increased δ in the high-frequency region. The plateau zone in phase angles could be due at least in part to the elastic networks formed by polymer cross-linking and polymer-bitumen entanglements in WP-BMR. The swelling of crumb-rubber particles in BMRs leads to a decreased δ at lower frequencies. Along with the aging, the decreased δ had a rise at low frequencies, due at least in part to the viscous response which is due at least in part to rubber devulcanization during aging. Based on the δ-based aging index, the UV-aging resistance of WVO-BMR (aging index 7.7%) was better than that of WP-BMR (aging index 8.6%) at 10 rad/s.

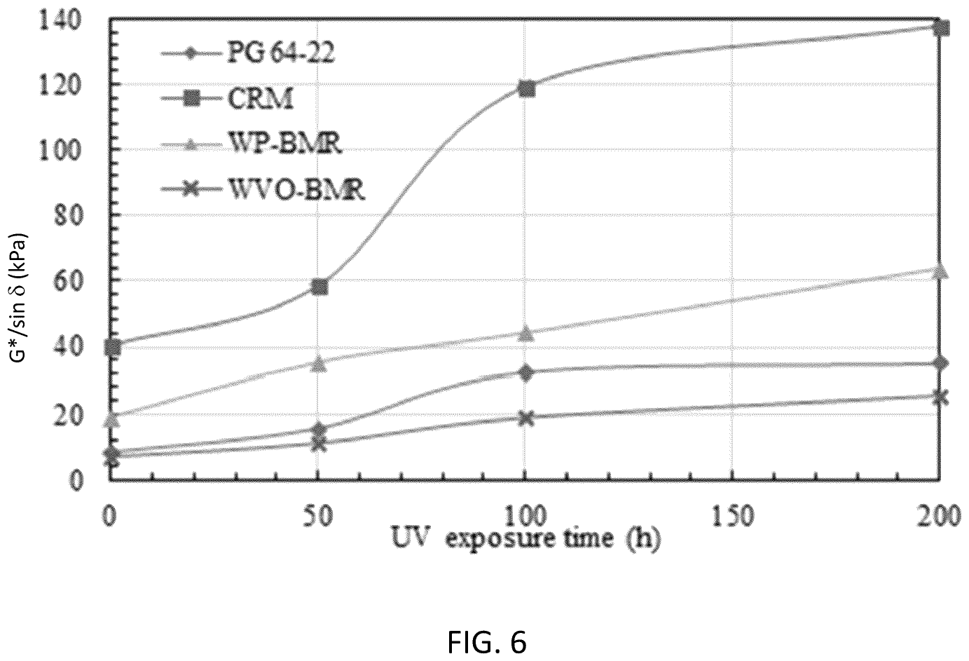

Evaluation of rutting resistance. One of the indicators that measures the extent of UV aging in a bitumen is rutting resistance, defined as the ratio of the complex modulus to the sine of the phase angle (G*/sin δ) at 10 rad/s. FIG. 6 shows changes in the G*/sin δ values at 52° C. after UV aging for neat bitumen, crumb-rubber-modified bitumen, and the two types of bio-modified rubberized bitumen. In one example, increases in G*/sin δ as aging progressed indicate hardening of bitumen throughout UV aging. As shown in FIG. 6, the addition of crumb rubber to bitumen, CRM, produces the highest G*/sin δ values, while the WVO-BMR has the lowest G*/sin δ values. The aging rate at each period of UV exposure is also informative; the aging rate is measured by dividing the change in G*/sin δ by the exposure time of each aging period (0-50 h, 50-100 h, and 100-200 h). Due at least in part to the calculation of aging rate, CRM has the highest aging rate at each UV aging period, and WVO-BMR has the lowest aging rate.

After 200 h aging, WP-BMR has the lowest aging index due at least in part to G*/sin δ (234.7%), showing the greatest resistance to UV aging, followed by CRM (241.6%), WVO-BMR (275.1%), and PG 64-22 with the highest aging index of 327.2%, indicating the least resistance to UV aging as provided in Table 6. The UV-aging resistance of the bio-modified rubberized bitumens, WVO-BMR and WP-BMR, depends on the source of the bio-oil.

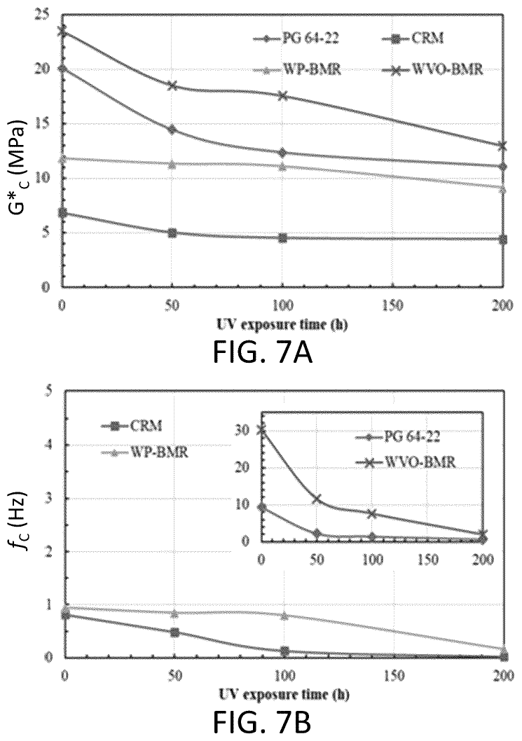

Crossover modulus and frequency. The effect of the two bio-oils on bitumen aging was studied using a frequency sweep test to assess the crossover points. The crossover point is defined by the crossover frequency, fₑ, and the crossover modulus, G_{c}*, G_{c}* and f_{c} can be correlated to a polymer's zero-shear viscosity (ZSV), molecular weight, and molecular distribution: higher values of ZSV, molecular weight, and polydispersity can cause lower values of G_{c}* and f_{c}. In one example, G_{c}* and f_{c} are reliable parameters to track aging. Increases in polarity during aging can intensify intermolecular interactions and agglomeration in aged bitumen. UV exposure increases the values of ZSV, molecular weight, and polydispersity, leading to decreases in G_{c}* and f_{c} as shown in FIGS. 7A and 7B, respectively. FIGS. 7A and 7B show that WVO-BMR exhibited the highest sensitivity to UV exposure, followed by PG 64-22. Table 6 shows the values for the aging index based on G_{c}* and f_{c}. It was found that WP-BMR had the lowest G_{c}*-based aging index (23.0%) and the lowest f_{c}-based aging index (81.8%), indicating that WP-BMR had the most resistance to UV aging. WVO-BMR had a higher G_{c}*-based aging index (44.9%) and a higher f_{c}-based aging index (93.5%). The difference in performance between the WP and WVO bio-oils in response to UV aging could be attributed to the difference in chemical composition: the high concentration of phenolic compounds and other reactive components such as furfural in wood-pellet oil has been shown to delay thermal aging and UV aging.

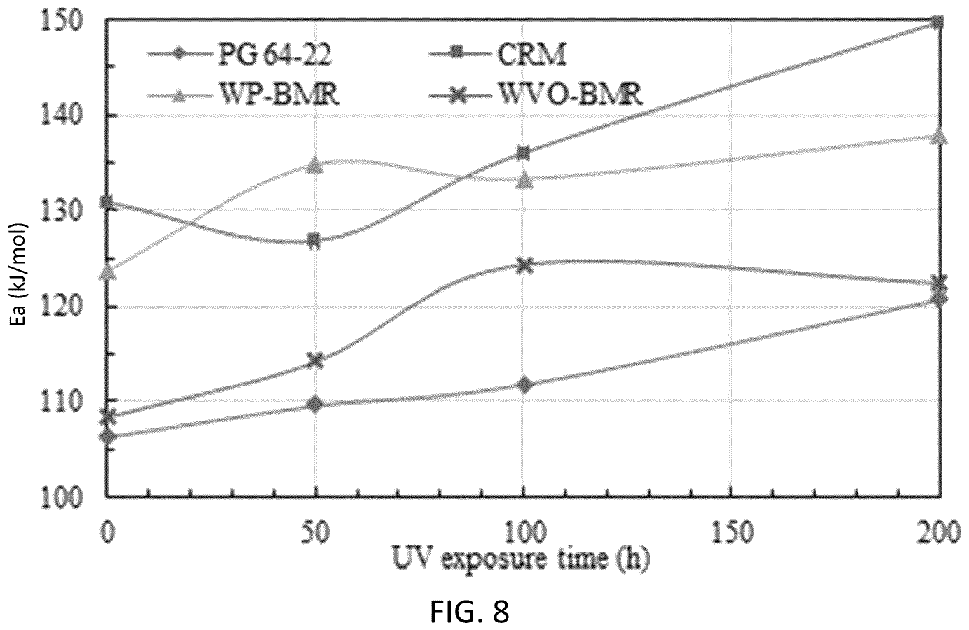

Activation energy. FIG. 8 compares the activation energy (Eₐ) of neat bitumen, crumb-rubber-modified bitumen, and the two bio-modified rubberized bitumens, as a function of UV exposure times. The increased polarity of aromatics and resins caused by aging makes these species insoluble enough to separate in heptane or to agglomerate to the original asphaltenes. These chemical changes produce an increase of the asphaltene content and a decrease of aromatics and resins in the aged bitumen. Oxidative aging promotes intermolecular interactions and asphaltene agglomeration in bitumen, which affect the activation energy. In one example, changes in the activation energy at each level of aging depend on the degree of agglomeration in the aged bitumen. For example, at a low aging time, nanoaggregates can shear against each other and may make a reduction in activation energy. The trends observed in FIG. 8 for CRM in 0-50 h UV aging period may be due at least in part to nanoaggregates shearing against each other and creating a reduction in activation energy. As aging progresses, increasing molecular agglomerations due at least in part to aromatization and carbonation could increase the activation energy. As shown in FIG. 8, after 200 h UV exposure, the activation energy of all bitumens increased compared to the unaged samples. Since bio-oils have different effects on the oxidative aging and agglomerations, the degree of increase in activation energy is different for each bio-modified sample.

Table 6 provides the aging index using activation energy for all bitumen samples. The data indicate that rubberized bitumen with WP (WP-BMR) has the lowest Eₐ-based aging index of 11.5%, showing the highest resistance to UV aging compared to the other bitumen samples. The lower Eₐ-based aging index for WP-BMR compared to that for WVO-BMR could be attributed to the presence of polar aromatics such as phenolic compounds in WP from the decomposition of lignin in the wood biomass. Phenolic compounds may prevent oxidative aging and demote agglomeration during UV aging, causing a reduction in activation energy.

Chemical analysis. FTIR analysis was performed to track the chemical changes in bitumen samples after UV aging. The amount of carbonyl groups increases in bitumen as aging progresses. Table 6 shows that after 200 h UV exposure, bio-modified rubberized bitumen samples (BMRs) have lower values of the carbonyl-based aging index compared to neat bitumen and crumb-rubber-modified bitumen. Between the two BMRs, WVO-BMR has a lower carbonyl-based aging index (19.9%) compared to WP-BMR (56.8%). The difference between the two BMRs in chemical changes based on carbonyl functional groups is due at least in part to the chemical composition of the bio-oil used. Comparing the two bio-oils, WVO is based on vegetable oil containing unsaturated fatty acids; these can act as free-radical scavengers during UV aging, to protect bitumen fragments from oxidation and thereby prevent carbonyl-group formation. Unsaturated fatty acids are also able to absorb UV and could act as a protective shield against UV radiation. The wood-based bio-oil, WP, has a high percentage of unsaturated compounds that are vulnerable to UV radiation, and are converted to ketones and carboxylic acids (carbonyl-containing groups) by reacting with UV-induced free radicals. These compounds could act as sacrificial compounds that are oxidized first, before fragments of the bitumen itself, thus protecting the bitumen against UV aging. Another distinction between the chemical compositions of the WP and WVO bio-oils is the higher concentration of phenolic compounds in the WP bio-oil. The increased carbonyl signature supports the hypothesis that the antioxidant activity of phenolic compounds through scavenging free radicals leads to phenoxyl radicals and quinone derivatives (containing carbonyl groups). In one example, the formation of carbonyl groups could be higher in the WP bio-modified bitumen due at least in part to the WP bio-modified bitumen having a high content of phenolic compounds. These carbonyl-containing compounds may not intensify agglomerations in aged bitumen and may not create performance deterioration of asphalt. This may be due at least in part to WP-BMR's lower values for the aging index based on activation energy (Table 6).

To evaluate the extent of UV aging from different perspectives, Table 6 summarizes for each bitumen the aging indices based on different properties. The last column in Table 6 shows the bitumen samples that have the most resistance against UV aging are the bio-modified bitumens. WP-BMR appears to better resist aging than WVO-BMR. Modifying rubberized bitumen with WP bio-oil can produce a higher capability to delay UV aging.

Although this disclosure contains many specific embodiment details, these should not be construed as limitations on the scope of the subject matter or on the scope of what may be claimed, but rather as descriptions of features that may be specific to particular embodiments. Certain features that are described in this disclosure in the context of separate embodiments can also be implemented, in combination, in a single embodiment. Conversely, various features that are described in the context of a single embodiment can also be implemented in multiple embodiments, separately, or in any suitable sub-combination. Moreover, although previously described features may be described as acting in certain combinations and even initially claimed as such, one or more features from a claimed combination can, in some cases, be excised from the combination, and the claimed combination may be directed to a sub-combination or variation of a sub-combination.

Particular embodiments of the subject matter have been described. Other embodiments, alterations, and permutations of the described embodiments are within the scope of the following claims as will be apparent to those skilled in the art. While operations are depicted in the drawings or claims in a particular order, this should not be understood as requiring that such operations be performed in the particular order shown or in sequential order, or that all illustrated operations be performed (some operations may be considered optional), to achieve desirable results.

Accordingly, the previously described example embodiments do not define or constrain this disclosure. Other changes, substitutions, and alterations are also possible without departing from the spirit and scope of this disclosure.

What is claimed is:

1. A bio-modified bitumen comprising:
bitumen comprising organic compounds; and
a bio-oil comprising phenolic compounds and derived from wood biomass, wherein the phenolic compounds formhydrogen bonds, covalent bonds, or both with the organic compounds in the bitumen.

2. The bio-modified bitumen of claim 1, wherein the organic compounds comprise: 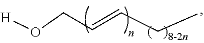
wherein n is 0-4; 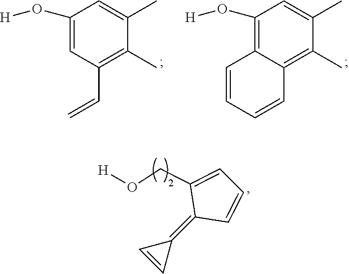
or any combination thereof.

3. The bio-modified bitumen of claim 1, wherein the phenolic compounds comprise one or more functional groups selected from —CH₃, —C₂H₃, —C₃H₅, —CHO, —OCH₃, and —OH.

4. The bio-modified bitumen of claim 1, wherein the phenolic compounds comprise phenol; 2,6-dimethylphenol, 2,6-dimethoxyphenol, benzene-1,2-diol, 4-methylbenzene-1,2-diol, 2-methoxy-4-methylphenol, 4-ethenyl-2-methoxyphenol, 2-methoxy-4-(prop-2-en-1-yl)phenol, or any combination thereof.

5. The bio-modified bitumen of claim 1, wherein the organic compounds comprise volatile organic compounds (VOCs).

6. The bio-modified bitumen of claim 1, wherein the wood biomass comprises wood pellets.

7. The bio-modified bitumen of claim 1, wherein the bio-modified bitumen comprises about 5 wt % to about 15 wt % of the bio-oil.

8. The bio-modified bitumen of claim 1, further comprising crumb rubber particles.

9. The bio-modified bitumen of claim 8, wherein the bio-modified bitumen comprises about 5 wt % to about 15 wt % of the crumb rubber particles.

10. A building material comprising the bio-modified bitumen of claim 1.

11. A bio-modified asphalt comprising:
the bio-modified bitumen of claim 1; and
aggregate material.

12. The bio-modified asphalt of claim 11, wherein the aggregate material comprises one or more of rock, sand, gravel, and slags.

13. A building material comprising the bio-modified asphalt of claim 11.
